(19) United States
(12) Patent Application Publication
(10) Pub. No.: US 2001/0043194 A1
(43) Pub. Date: Nov. 22, 2001

(54) MOTION PICTURE VIDEO DISPLAY DEVICE

(76) Inventor: ALAN AMRON, SYOSSETT, NY (US)

Correspondence Address: Brian K. Dinicola, 34 Avenue E, Monroe Twp, NJ, 08831-2316, US

(21) Appl. No.: 09/149,373

(22) Filed: Sep. 8, 1998

Related U.S. Application Data
(63) Continuation-in-part of application No. 09/137,380, filed on Aug. 20, 1998.

(51) Int. Cl. G09G 5/00

(52) U.S. Cl. 345/169

(57) ABSTRACT

A hand-held portable motion picture video display system comprising a housing, a flat panel display, a removable plug-in memory storage module for storing data representative of a motion picture; and a user input interface operable to cause the motion picture to be visually displayed and audibly reproduced.

The motion picture is stored as compressed video in the ratio of at least 200:1 and displayed at 30 frames per second, to avoid jerky and unlife-like motions.

### RELATED APPLICATION

This is a continuation-in-part of application Ser. No. 09/137380 filed Aug. 20, 1998 entitled “VIDEO DISPLAY DOCUMENT”.

### BACKGROUND

1. Field of the Invention

This invention relates to video devices to display motion pictures and particularly to such portable hand-held battery operated video devices.

2. Discussion of the Prior Art

At the present time there are a number of systems and devices for viewing motion pictures using video, i.e. using TV (Television). For example a motion picture is broadcast over-the-air, or over cable, and it is simultaneously viewed on TV. An alternative is to view a motion picture which has been recorded on a cassette tape using a VCR (Video Cassette Recorder) which plays through the TV. The VCR cassette may be recorded “off air” by the user, or a pre-recorded cassette may be purchased or rented. These systems require a VCR and TV and are not commercially available as a portable hand-held unit.

There has also been announced a number of “video-on-demand” systems in which a user selects, and pays for, a movie (motion picture) which is transmitted to the user over cable. Such systems are not widely available and require a special converter box, a cable connection and a TV set, consequently they are not portable. In addition, motion picture recordings in the format of discs have been marketed as providing superior video images to VCR. However, such discs i.e. Philips and Sony, require a disc player and a TV and have not been used as a hand-held portable system to view motion pictures.

There is a need for a small lightweight motion picture video player, which is a complete unit, including the battery, playback electronics, the recorded motion picture and the viewing screen. Preferably the device would weight less than one pound, have a viewing screen of at least 4 by 5.5 inches, present the motion picture at standard video frame rate of 30 frames per second to avoid jerky and unlifelike motion, and be able to display an entire 90-120 minute motion picture.

Other prior art which may be relevant to this invention is described hereinafter.

U.S. Pat. No. 4,159.417 to Rubincam discloses a portable, battery powered electronic viewer that reads and displays data stored in a holographic memory card. The memory can be page oriented so that each hologram represents a page in a book and the entire book can be stored on one card.

U.S. Pat. No. 4,545,023 to Mizzi discloses a hand-held, battery-powered computer comprising various electronic cards and a flat touch screen. The touch screen eliminates the need for a keyboard or other input keypads. The screen can display alphanumeric characters and graphics. Any area touched on the screen is identified by its coordinates.

U.S. Pat. No. 4,918,632 to York discloses a battery-powered, portable touch screen computer designed with a multitude of holes along one edge so that the computer can be disguised as a 3-ring binder notebook to avoid theft.

U.S. Pat. No. 5,031,119 to Dulaney et al. discloses a hand-held, keyboardless computer with a split liquid crystal display (LCD) screen. The top half of the screen displays an application and the bottom half displays a keyboard.

U.S. Pat. No. 5,109,354 to Yamashita et al. discloses a portable pocketbook device comprising a touch screen or pressure sensitive LCD display, a cursor, function keys and an on/off switch that is activated when the pocketbook device is opened.

U.S. Pat. No. 5,339,091 to Yamazaki et al. discloses a portable electronic book comprised of a LCD display, keybutton inputs or other external input facilities, an on/off switch activated by opening the cover, a hinged cover, a solar cell in the cover to power the unit, a connector for an external power source and a disc drive to read information from optical or floppy discs. Other memory devices could include magnetic tape and EPROMS (Electrically Programmable Read Only Memory). The screen incorporates pressure or photo sensors so the user can select and emphasize portions of the text for later recall.

### SUMMARY OF THE INVENTION

The aforementioned needs are addressed, and an advance is made in the art, by a motion picture video display system comprising a housing, a flat panel display, a plug-in memory storage module for storing data representative of an audio/video movie, and a user input interface operable to initiate Playback, Fast Forward, Forward Frame by Frame, Fast Rewind, Rewind Frame by Frame, Pause and Stop on the flat panel display.

The entire device, except for manual control switches (start/stop, fast forward etc) has no moving parts. It does not have a disc drive or other electromechanical playback mechanisms or an image taking lens or an image-to-signal transducer. The device is thin, less than two inches thick, as it uses a flat display i.e LCD (Liquid Crystal Display) and not a CRT (Cathode Ray Tube). The device is lightweight, weighing less than one pound. It uses a rechargeable battery and it displays an entire motion picture of 90-120 minutes without recharging.

The plug-in memory storage module is solid state, for example, each module contains a movie and the modules may be separately purchased or rented.

One embodiment, except for a start/stop switches is entirely without moving parts. It uses a touch display screen, which is a touch sensitive transparent sheet, over the video display screen. The video screen shows control icons (REW—Rewind, FF—Fast Forward, PS—Pause, PL—Play, F×F—Forward Frame by Frame, B×F—Back Frame by Frame). A user touches the touch screen at the area indicated by the icon to generate a control command.

Preferably the device is manufactured to prevent the unauthorized copying of the plug-in modules. For this purpose three levels of security may be used.

First, the plug-in module is a card which is a non-standard card having a proprietary size and configuration. It will not fit into a standard lap top computer and standard PCMCIA memory cards will not fit into the connector interface port of the device.

Secondly, the electrical contacts on the edge of the card are non-standard and proprietary, in their arrangement, so that the card (memory module), having a motion picture recorded thereon, can not be downloaded into a computer.

Thirdly, the data, which is compressed video, is recorded with a data encryption key or a nonstandard compression is used. The device has the correct key to decode the data but ordinary computers do not have the decoding key.

The device has an earphone port, which when used, will automatically silence the device's speaker. A movie may be viewed in privacy (without disturbing others) while traveling, for example while commuting on a train. The device may be given to children riding in the back seat of a car on a trip, and they may watch children's films. It may be viewed, at home, while someone, else is watching TV or watching a different movie. It may be used in a fitness club while on an exercize is machine; in a multi-bed hospital room; waiting for one's turn at a doctor's office; or to study films in a library without bothering others.

The data is compressed video data with the compression ratio being at least 100:1 and preferably 200:1 or more (ratio of compressed data to original data).

### BRIEF DESCRIPTION OF THE DRAWINGS

The various features and advantages of the invention will become apparent from a consideration of the detailed description which follows taken in conjunction with the drawings, in which:

FIG. 1 is a perspective view depicting a touch-screen implementation of the present Invention;

FIG. 2 is a block diagram depicting the interactions of the various internal components disposed within the housing of the illustrative embodiment of FIG. 1;

FIG. 3 depicts an alternate embodiment of the present invention which utilizes discrete individual pushbutton operators to advance, rewind, and initiate playback of the stored video motion picture;

FIG. 4 is a block diagram depicting the interactions of the various internal components within the housing of the illustrative embodiment of FIG. 3; and

FIG. 5 depicts the preferred technique for transferring video data into the motion picture video display device of the present invention.

### DETAILED DESCRIPTION OF THE INVENTION

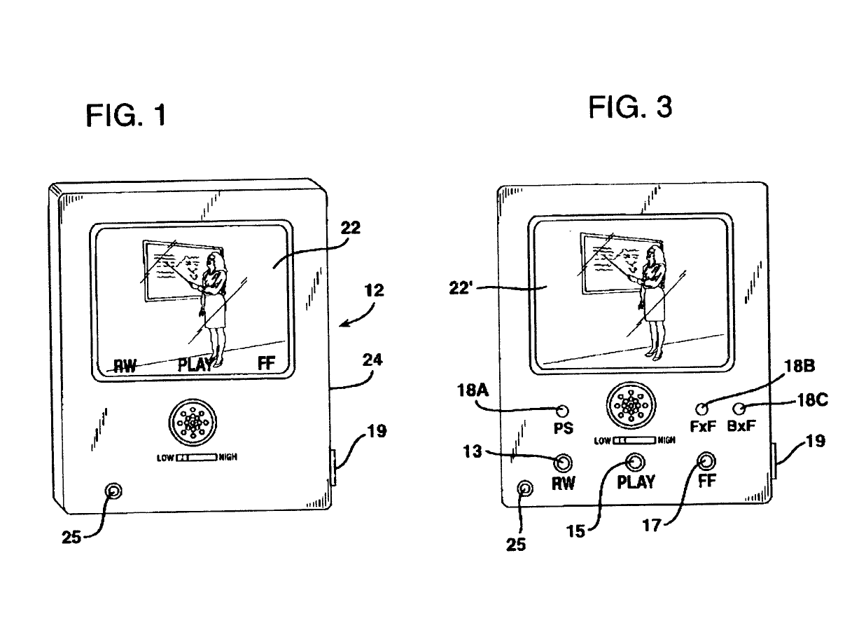

With initial reference to FIG. 1. Video display device 12 includes a flat panel display 22 disposed within a housing 24. Housing 24 further includes a speaker 26 and volume control 27 for audibly reproducing sounds accompanying the video. An earphone jack 25 permits a pair of conventional earphones to be connected to the device 12 to permit private listening to the audio portion of the motion picture film. When an earphone jack is inserted the sound to the speaker is cut off.

Although a three color active matrix type screen is preferred, it is also contemplated that less costly screen types, as for example, a mono-color liquid crystal display screen, may be also be employed. As best seen in FIG. 1, video display housing 24 is thin and flat—in the range of four to twelve inches wide and preferably eight inches wide, and in the range of four to twelve inches long (high) and preferably nine inches long, with a thickness in the range of 0.1 to 2.0 inches being preferred and a thickness of between 0.25 and 0.5 inches being especially preferred. The ratio of width and length to thickness is at least 3:1 and preferably in the range of 5:1 to 20:1. The video display device does not have an image taking lens, such as a zoom lens, or an image to data or signal transducer, such as a charge coupled device (CCD). It has no moving parts, except for manual control switches.

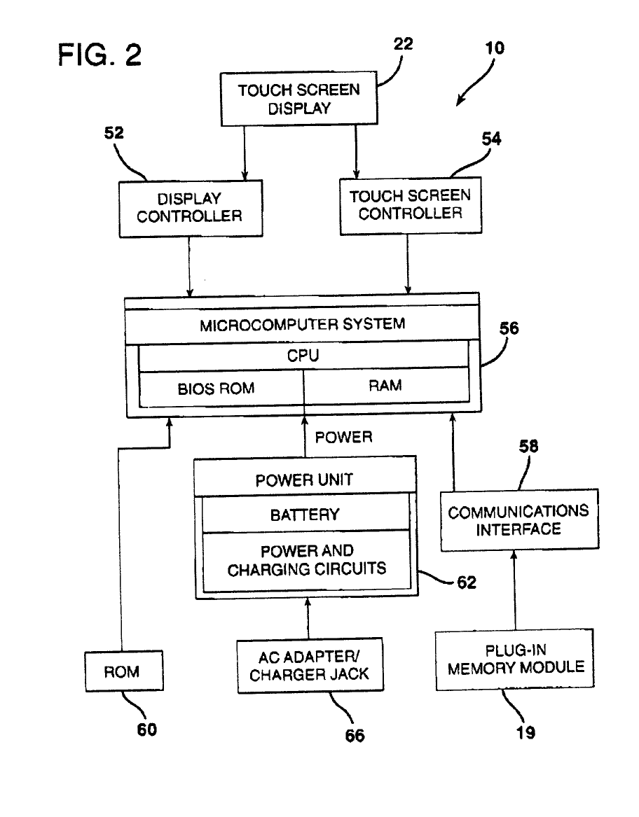

Turning now to FIG. 2, there is shown in block diagram form an illustrative configuration of the electronic processing system employed by video display device 12 in accordance with the present invention. As seen in FIG. 2, the electronic processing system 70 of video display device 12 of FIG. 1 comprises a single touch-sensitive display screen 22 mounted within housing section 24a (FIG. 1), display controller 52, touch screen controller 54, a microprocessor and memory module 56, a communication interface 58, a plug-in memory storage unit 19 for storing input video data, and an internal power unit 62 with battery, all configured into a handheld, portable unit.

Video memory storage unit 19 serves to store video data which, in accordance with an illustrative embodiment of the present invention, is stored as an AVI or MPEG-2 (Motion Picture Experts Group) encoded data file, with microprocessor system 56 being configured with appropriate software to function as an MPEG-2 or avi file decoder. Illustratively, the ROM 19 memory storage device may comprise 500 to 1,000 megabytes or more of memory such as provided by PCMCIA memory storage cards, solid state EEPROMs, flash memory devices, bubble memory, or the like, depending upon the actual amount of information to be stored on the device By way of illustrative example, with a ROM memory storage device of approximately 300 megabytes, the video display device 12 of the present invention will have sufficient storage to store up to one hundred and twenty (120) minutes of compressed video data (and accompanying audio) in its entirety.

The electronic processing system of the illustrative embodiment of FIG. 2 controls and monitors the operations of the video display device 12 in accordance with user requests and under software control, the system comprising touch screen controller 54, display controller 52, and microcomputer system 56 with random access memory (RAM). Microcomputer system 56 comprises the CPU which is controlled by the proprietary operating system embedded in a solid-state device, the BIOS ROM, and random access memory (RAM) that provides the primary memory space to write, store and retrieve information and program instructions used by the CPU. The microcomputer system 56 comprises a general-purpose microprocessor with supporting circuitry such as a logic board with an Intel 486DX2/66 MHz processor or better, or with a Pentium processor, a PowerPC processor with supporting circuitry such as a 100 MHz 603e processor; a RISC (reduced instruction set configuration) chip with supporting circuitry; or the like.

The video display device is powered from the power unit 62 that comprises one or more rechargeable batteries and power and charging circuits. These power and charging circuits control and distribute battery power or converted AC line power, control the charging of the internal battery or batteries when the device 12 is connected to an external AC adapter/charger device via the AC adapter/charger jack 66 and controls switchover between battery power and external AC line power when said AC power is available via the AC adapter/charger device. The rechargeable battery comprises a lithium ion battery, a nickel hydride (NiM) battery, or the like. To use the system of the present invention the user actuates an on/off switch (not shown) which powers up the device. This action automatically applies power to the unit and displays the play, stop, fast forward, and rewind icons (not shown) on flat panel display 22. When the user touches the play icon, playback of the stored video is initiated and played in a continuous loop until the operator touches the stop, fast forward, pause or reverse icon or switches the system off.

It will, of course, be readily appreciated by those skilled in the art that the system of the present invention may be configured to handle compressed video input in any desired format and to encode, compress, and decompress such signals as necessary to display the applicable video sequence when needed. The compressed digital data representing the video program (video motion picture) is a “proprietary” compressed video data. Because it is proprietary it may not be derived from the Internet, as well as from digital and analog camcorders. Such proprietary compressed video may be derived from MCP (motion compensated prediction); (MCI) motion compensation interpolation; MPEG (Motion Pictures Experts Group) I or II; AVI; and International Telegraph and Telephone Consultative Committee (CCITT). It is preferably encoded and may be decoded only by an encrytion key which is part of the CPU.

Touch screen display screen 22 is mounted on the upper, inside surface of the housing section 24a, extends virtually over the entire face thereof, and is electrically connected to the other circuits and components of the video display device 12. By way of illustrative example, touch screen display screen may be configured as a liquid crystal display (LCD) type screen or an active matrix display type screen that employs an array of addressable transistors such as thin-film transistors (TFT) or the like, wherein each color dot or pixel is activated by a group of three transistors, one each for red, green and blue. Various embodiments of the video display device comprise differing screen and case sizes. For the reasons discussed above, however, an overall housing size of 8 inches by 9 inches, taken with the miniaturization of the conventional electronic components employed herein, will typically serve as the decisive criteria in selecting the final size. Although a VGA 640 by 480 pixel resolution LCD or active matrix display provides acceptable detail for text and for some graphics, the preferred display for motion picture video has at least a 800 by 600 pixel resolution and at least 256 colors. Preferably the display screen 22 is a three-color active matrix LCD with a replaceable fluorescent bulb and a reflector for back lighting.

In the embodiment of FIGS. 1-2, a touch-sensitive transparent plate (not shown) covers the screen and is further comprised of resistive touch, capacitive touch, infrared beam touch, or the like. The touch-sensitive transparent plate used in the video display device of the present invention is typically less than 0.01 inch in thickness. A flexible flat cable is typically used to connect the touch-sensitive transparent plate to its touch screen controller; although other connections methods are also employable. The touch-sensitive plate contains a matrix of touch-sensitive areas over its entire surface. The outlines of these areas can be programmed to be recognized to coincide with graphics or other information displayed on the underlying display screen.

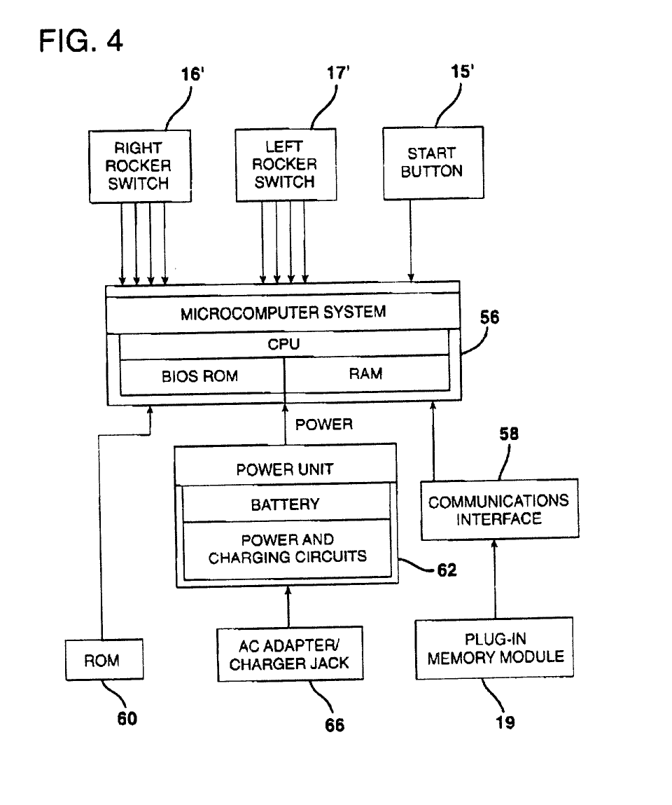

Turning now to FIGS. 3-4, the video display device 12′ of the present invention is almost identical to the system depicted in FIG. 1. Essentially, the differences therebetween relate to the substitution of a single section housing 24, as well as discrete mechanical pushbuttons 13, 15, 17 and 18A-18C (as opposed to a touch screen interface) for the Rewind (RW) 13, Play 15, Fast Forward (FF) 17 and pause 18A command input functions as well as Forward frame-by-frame (F×F) 18B and Backward frame-by-frame (B×F) 18C. Corresponding modifications to the internal circuitry which are needed to accommodate the use of a mechanically actuated operator interface and are shown in FIG. 4, they are believed to be well within the level of skill of the ordinary artisan and a detailed illustration and discussion of the same has been omitted herein for clarity.

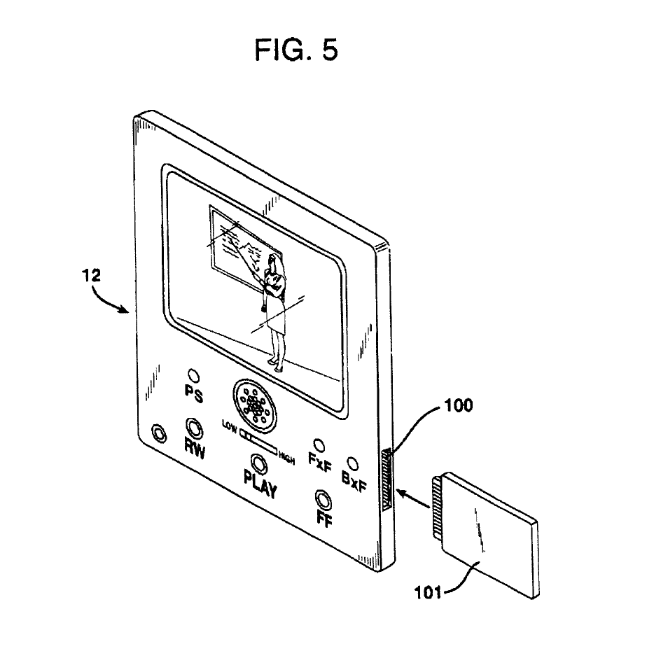

With reference now to FIG. 5, there is shown the preferred method for providing an interface to download information into the video display device. Specifically, the video display device includes a communication interface port for receiving proprietary compressed digital data representing a video motion picture. In the illustrative example of FIG. 5, the interface port 100 comprises a proprietary card slot, about the size of a PCMCIA card slot, for receiving a proprietary memory card 101 having stored thereon compressed digital data representative of a video motion sequence. The data is written onto card 101 by the factory and is sold as a complete movie.

Modifications in the design include using a built-in updatable memory module instead of a replaceable plug-in module. A video input port may be used to load compressed video data into the memory module, for example an RS-232 port. The memory module is solid-state and may be EEPROMS, flash memory or bubble memory. As used herein the terms “compressed data” and “compressed video data” mean a compression of at least 100:1, and preferably at least 200:1, the ratio being original data to compressed data.

What is claimed is:

1. A hand-held portable motion picture display device without moving parts except for manual switches and without an image acquiring lens and an image to signal transducer, the device comprising:
a housing having a maximum thickness of less than two inches and having a ratio of each of width and length to maximum thickness of at least three to one;
a flat panel display received within said housing;
a machine-readable video storage module operative to store said motion picture as compressed video digital data;
an operator interface means for inputting a user playback command, said operator interface means
comprising one of a pushbutton operator and a touch screen operator displayed on said flat panel display; and
a processor operatively associated with the video storage module, said processor being responsive to said user playback command to cause stored video data to be read from said video storage module and to display said video data at the rate of 15-40 frames per second on said panel display.

2. The video display device of claim 1, wherein said operator interface means comprises
a touch screen interface defining a first touch screen operator for initiating playback of the motion video picture, a second touch screen operator for initiating rewinding of the motion picture, and a third touch screen operator for initiating fast forwarding of the motion picture.

3. The video display device of claim 1, wherein said housing is thin and flat and has a width of five to eight inches, a length of five to eight inches; and a thickness of less than about one inch.

4. A hand-held portable motion picture display device, without moving parts except for switches and;
without an image taking lens and an image to signal transducer, the device including
a housing having a maximum thickness of less than two inches and having a ratio of each of width and length to maximum thickness of at least three to one,
a flat panel display received within said housing,
a plug-in removable machine-readable video storage module operative to store, as compressed video digital data, said motion picture; The compression being at least the ratio of 200:1 of original video data to compressed video digital data;
an operator interface for inputting a user playback command, said operator interface comprising one of a pushbutton operator and a touch screen operator displayed on said flat panel display; and
a processor operatively associated with the video storage module, said processor being responsive to said user playback command to cause stored video digital data to be read from said video storage module and displayed on said panel display at the rate of at least 15 frames per second.

5. A motion picture display device as in claim 4 wherein the video storage module is a flat card which is different in size from a standard PCMCIA card.

6. A method of preparing and presenting a motion picture, comprising the steps of:
providing a hand-held portable motion picture display device without moving parts except for switches, the device including a housing which is thin and flat and having a ratio of each of width and length to thickness of at least three to one, a flat panel display, a machine-readable video storage module operative to store data representative of a motion picture to be presented, said module being a removable plug-in module, an operator interface for inputting a user playback command, the operator interface
comprising one of a pushbutton operator and a touch screen operator displayed on the flat panel display, and a processor operatively associated with the video storage module, the processor being responsive to said user playback command to cause stored video data to be read from the video storage module, the video display device being without an image taking lens and an image to signal transducer;
supplying a motion picture in the form of compressed video digital data to the video storage module for storage therein, and plugging the video storage module into the device.

7. The method of claim 6, further including a step of inputting a security code into the module simultaneously with performing said supplying step.

8. A method of displaying a motion picture, said method comprising the steps of:
providing a hand-held portable video display device including a housing which is thin and flat and
having a ratio of each of width and length to thickness of at least three to one, a flat panel display, a machine-readable video storage module operative to store compressed video data representative of a motion picture to be presented, an operator interface for inputting a user playback command, the operator interface comprising one of a pushbutton operator and a touch screen operator displayed on the flat panel display, and a processor operatively associated with the video storage module, the processor being responsive to said user playback command to cause stored video data to be read from the video storage module, the video display device being without an image taking lens and an image to signal transducer; and
inputting a user playback command causing said video display device to display said motion picture at the rate of 15-40 frames per second.

9. A motion picture display device which is a hand-held portable device weighing less than one pound and is an entirely solid state device without moving parts except for switches and is a play back device without an image acquiring lens and an image to signal transducer, the display device comprising:
a housing which is thin and flat, having a ratio of at least three to one; and within the housing
flat panel display means to display a motion picture;
a video memory means to receive and store compressed data representing the motion picture, the compression being in the ratio of at least 200:1 of the uncompressed data to compressed data;
manual switch means to be user operated to start the motion picture; and
microcomputer processor means to control the reading of data from the video memory means, decompression of the data, and display of the decompressed data on the flat panel display means in response to operation of the manual switch means.

10. A hand-held portable motion picture video display device which weighs less than one pound and is an entirely solid-state device without moving parts, except for switches, and which is only a play-back device without an image acquiring lens and an image-to-signal transducer, the motion picture video display device comprising:
a housing which is thin, having a maximum thickness of one inch, and within the housing electrically connected together a battery;
a communication interface connector means for receiving a plug-in card having thereon compressed digital data representing a motion picture; the compression being in the ratio of at least 200:1 of original video data to compressed video digital data;
a flat panel display means for displaying a motion picture;
video memory means for receiving and storing the compressed digital data including a removable plug-in card which is connected into said connector means;
manual switch means to be user-operated to start the motion picture; and
microcomputer processor means for controlling reading of the digital data from the video memory means, decompressing the digital data, and display of the decompressed digital data as a video on the flat panel display means. at the rate of at least 15 frames per second.
